(19) United States
(12) Patent Application Publication
(10) Pub. No.: US 2022/0253638 A1
(43) Pub. Date: Aug. 11, 2022

(54) INFORMATION PROCESSING APPARATUS AND NON-TRANSITORY COMPUTER READABLE MEDIUM STORING PROGRAM

(71) Applicant: FUJIFILM Business Innovation Corp., Tokyo (JP)

(72) Inventors: Shunichi KIMURA, Kanagawa (JP); Yutaka KOSHI, Kanagawa (JP)

(73) Assignee: FUJIFILM Business Innovation Corp., Tokyo (JP)

(21) Appl. No.: 17/396,754

(22) Filed: Aug. 8, 2021

(30) Foreign Application Priority Data
Feb. 8, 2021 (JP) 2021-018349

(51) Int. Cl. G06K 9/34; G06K 9/46; G06K 9/62

(52) U.S. Cl. CPC G06K 9/344; G06K 9/6202; G06K 9/46

(57) ABSTRACT

An information processing apparatus includes a processor configured to extract a specific text string from a text string which is a text recognition target, calculate a reliability degree of text recognition for the specific text string, and output the reliability degree as a reliability degree of text recognition for an entirety of the text string which is the text recognition target.

### CROSS-REFERENCE TO RELATED APPLICATIONS

This application is based on and claims priority under 35 USC 119 from Japanese Patent Application No. 2021-018349 filed Feb. 8, 2021.

### BACKGROUND

### (i) Technical Field

The present invention relates to an information processing apparatus and a non-transitory computer readable medium storing a program.

### (ii) Related Art

A technology is known in which text recognition is performed on a text string and a reliability degree of the text recognition is calculated.

JP2006-244518A describes a system that calculates a certainty degree of a content for each of a plurality of items included in data, and dynamically changes a presentation method by using the calculated certainty degree.

JP2016-212812A describes an apparatus in which a text recognition target is classified into any one of three types, in a case where the text recognition target is classified into a first type, a text recognition result is extracted, in a case where the text recognition target is classified into a second type, the text recognition result is extracted, and the text recognition target is controlled to be manually input, in a case where the text recognition target is classified into a third type, a plurality of persons manually input the text recognition target.

JP2020-46819A describes an apparatus in which in a case where a certainty degree is equal to or higher than a threshold value, a text recognition result of a document is determined, and in a case where the text recognition result and a text recognition result for an image representing a related document of the document do not coincide with each other even in a case where the certainty degree is equal to or higher than the threshold value, a warning is output.

JP2002-312365A describes an apparatus that performs text recognition on a document image to generate a text of a recognition result, determine a reprocessing range of the text recognition in the document image, adds a text of a result obtained by performing the text recognition again in the reprocessing range to the text of the recognition result to generate a search text, and executes searching by using the search text.

### SUMMARY

Meanwhile, it is conceivable to calculate and output a reliability degree of text recognition for an entirety of the text-recognized text string. In this case, as the number of texts included in the text string increases, accuracy of the reliability degree may decrease.

Aspects of non-limiting embodiments of the present disclosure relate to an information processing apparatus and a non-transitory computer readable medium storing a program that improve accuracy of text recognition for a text string of interest by a user, as compared with a case where a reliability degree of an entirety of a text-recognized text string is calculated and output.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to extract a specific text string from a text string which is a text recognition target, calculate a reliability degree of text recognition for the specific text string, and output the reliability degree as a reliability degree of text recognition for an entirety of the text string which is the text recognition target.

### BRIEF DESCRIPTION OF THE DRAWINGS

Exemplary embodiment(s) of the present invention will be described in detail based on the following figures, wherein:

FIG. 1 is a block diagram illustrating a hardware configuration of an information processing apparatus according to the present exemplary embodiment;

FIG. 2 is a block diagram illustrating a configuration of realizing a process according to Example 1; and

FIG. 3 is a block diagram illustrating a configuration of realizing a process according to Example 2.

### DETAILED DESCRIPTION

Basic Principle of Present Exemplary Embodiment

Hereinafter, a basic principle of the present exemplary embodiment will be described.

In the present exemplary embodiment, a specific text string is extracted from a text string of a text recognition target, a reliability degree of text recognition for the specific text string is calculated, and the reliability degree is output as a reliability degree of text recognition for an entirety of the text string which is the text recognition target.

The reliability degree of the text recognition is information (for example, a numerical value) indicating how reliable a result of the text recognition is, and may be called a certainty degree. As a method of calculating the reliability degree, various known technologies may be used. For example, the reliability degree may be calculated by using the technologies described in JP2006-244518A, JP2016-212812A, JP1993-040853A, JP1993-020500A, JP1993-290169A, and JP1996-101880A, or JP2011-113125A, JP2013-069132A, and the like.

For example, the reliability degree of text recognition for the specific text string is calculated, based on a reliability degree of the text recognition for each text constituting the specific text string. That is, the reliability degree of text recognition for each text constituting the specific text string is calculated, and the reliability degree of text recognition for the specific text string is calculated based on the reliability degree of text recognition for each text. For example, a product of the reliability degrees of text recognition for the respective texts constituting the specific text string, or a reliability degree of a text having the minimum reliability degree among a plurality of texts constituting the specific text string is used as the reliability degree of text recognition for the specific text string.

The specific text string is, for example, a text string according to a purpose of a user. For example, a text string which the user is paying attention to or a text string which is regarded as required is used as the specific text string. As a specific example, in a case where the user pays attention to a numeric text string in a text string of a text recognition target, the numeric text string is used as the specific text string.

As a method of extracting a text string from a result of the text recognition, various known technologies may be used.

For example, the text string may be extracted by using the technology described in JP2002-63197A or JP2002-312365A.

Here, a process according to the present exemplary embodiment will be described with reference to a specific example. For example, a text string of “billing amount is 1,000,000 yen every month.” is a text string of a text recognition target. By applying a text recognition process to an image representing the text string of a text recognition target, each text is recognized from the image, and a text string of the text recognition target is recognized. As the text recognition process, various known technologies may be used.

A specific text string is extracted from the text string of “billing amount is 1,000,000 yen every month.” which is a text recognition target. For example, the specific text string is part of the amount of money. Specifically, a “text string in which a text of “yen” is arranged at an end of a sequence of numbers and commas” is a specific text string. In this case, a text string of “1,000,000 yen” is extracted as the specific text string from the text string of a text recognition target.

A reliability degree of text recognition for each text constituting the specific text string of “1,000,000 yen” is calculated, and based on the calculation result, a reliability degree of text recognition for the specific text string of “1,000,000 yen” is calculated. Specifically, a reliability degree of text recognition for each of a text of “1”, a text of “,”, a text of “0”, a text of “0”, a text of “0”, . . . is calculated, and based on the calculation result, a reliability degree of text recognition for the specific text string of “1,000,000 yen” is calculated. For example, a product of the reliability degrees of text recognition for each text, or the minimum reliability degree is the reliability degree of text recognition for the specific text string of “1,000,000 yen”.

Reliability degrees of text recognition for each text constituting the text string of “billing amount is 1,000,000 yen every month.” which is a text recognition target are calculated, and a reliability degree of text recognition for the specific text string of “1,000,000 yen” maybe calculated, by using reliability degrees of text recognition for each text in the specific text string of “1,000,000 yen” among the calculation results.

The reliability degree of text recognition for the specific text string of “1,000,000 yen” is output as a reliability degree of text recognition for an entirety of the text string of “billing amount is 1,000,000 yen every month.” which is a text recognition target. That is, by using the reliability degree of text recognition for all the texts constituting the text string of “billing amount is 1,000,000 yen every month.” which is a text recognition target, instead of calculating and outputting the reliability degree of text recognition for an entirety of the text string of a text recognition target, the reliability degree of text recognition for the specific text string is output as the reliability degree of text recognition for an entirety of the text string of the text recognition target.

As another example, in a case where a text string of a text recognition target is a text string of “billing amount is $1,000.”, a text string of “$1,000” is designated as a specific text string, and a reliability degree of text recognition for the specific text string of “$1,000” is calculated. The reliability degree is output as a reliability degree of text recognition for an entirety of the text string of “billing amount is $1,000” which is a text recognition target.

Outputting the reliability degree includes, for example, displaying the reliability degree on a display, transmitting the reliability degree to a destination, printing the reliability degree on a recording medium such as paper, generating the reliability degree as voice, storing the reliability degree in a memory, and the like.

Configuration of Information Processing Apparatus 10

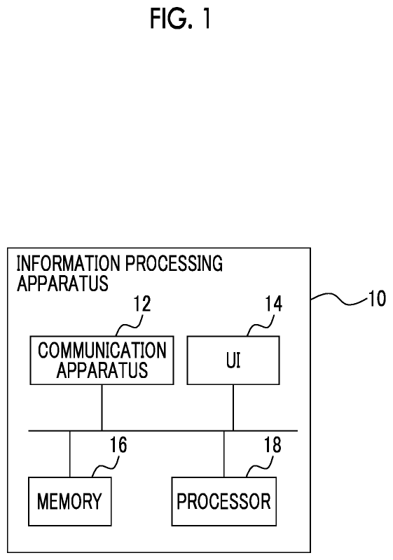

Hereinafter, an information processing apparatus 10 according to the present exemplary embodiment will be described with reference to FIG. 1. The information processing apparatus 10 is an apparatus that realizes the basic principle according to the present exemplary embodiment described above. FIG. 1 illustrates an example of a hardware configuration of the information processing apparatus 10.

The information processing apparatus 10 includes, for example, a personal computer (hereinafter, referred to as “PC”), a tablet PC, a smartphone, a wearable device (for example, augmented reality (AR) glass, virtual reality (VR) glass, hearable device, or the like), a telephone, a server, a scanner, a multifunction apparatus (for example, an apparatus including a scanner, a printer, a copier, or the like), and the like.

The information processing apparatus 10 accepts an image representing a text string of a text recognition target, recognizes each text from the image and recognizes the text string of the text recognition target by applying a text recognition process to the image, extracts a specific text string from a recognition result (that is, the text string of the text recognition target), calculates a reliability degree of the text recognition for the specific text string, and outputs the reliability degree as a reliability degree of text recognition for an entirety of the text string of the text recognition target.

The information processing apparatus 10 may accept the result of text recognition without executing the text recognition process. That is, the text string of the text recognition target is recognized by applying the text recognition process to the text string of the text recognition target by an apparatus other than the information processing apparatus 10. The information processing apparatus 10 may accept the recognition result (that is, a text string of the text recognition target), extract a specific text string from the recognition result, and output a reliability degree of text recognition for the specific text string as the reliability degree of text recognition for an entirety of the text string of the text recognition target.

FIG. 1 illustrates a basic configuration of the information processing apparatus 10. The information processing apparatus 10 includes, for example, a communication apparatus 12, a UI 14, a memory 16, and a processor 18.

The communication apparatus 12 is a communication interface having a communication chip, a communication circuit, and the like, and has a function of transmitting information to another apparatus and a function of receiving information from the other apparatus. The communication apparatus 12 may have a wireless communication function or a wired communication function.

The UI 14 is a user interface, and includes at least one of a display or an operation apparatus. The display is a liquid crystal display, an EL display, or the like. The operation apparatus is a keyboard, a mouse, an input key, an operation panel, or the like. The UI 14 may be a UI such as a touch panel having both a display and an input apparatus.

The memory 16 is an apparatus constituting one or a plurality of storage areas for storing various types of information. The memory 16 is, for example, a hard disk drive, various types of memory (for example, RAM, DRAM, ROM, or the like), other storage apparatuses (for example, an optical disk and the like), or a combination of at least two of the storage apparatuses. One or a plurality of memories 16 are included in the information processing apparatus 10.

The processor 18 is configured to control an operation of each unit of the information processing apparatus 10. The processor 18 may have a memory.

The processor 18 extracts a specific text string from a text string of a text recognition target, calculates a reliability degree of text recognition for the specific text string, and outputs the reliability degree as a reliability degree of text recognition for an entirety of the text string which is the text recognition.

In a case where the information processing apparatus 10 is a scanner or a multifunction apparatus, the information processing apparatus 10 includes an apparatus that reads an image from an original document.

Hereinafter, examples according to the present exemplary embodiment will be described.

### EXAMPLE 1

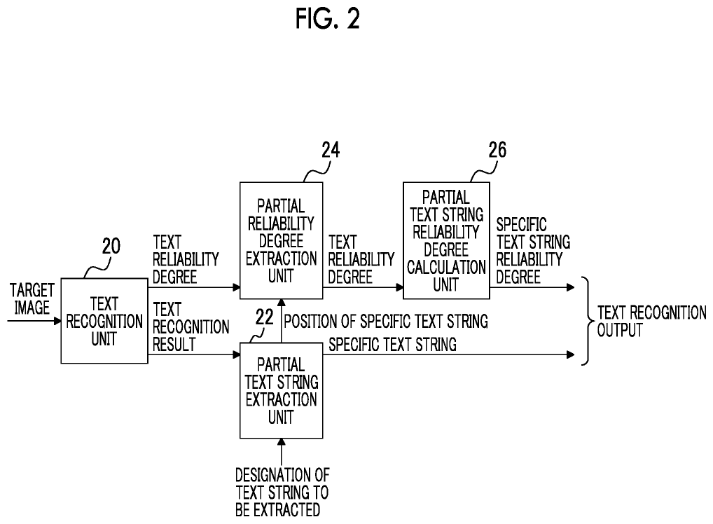

Hereinafter, Example 1 will be described with reference to FIG. 2. FIG. 2 illustrates a configuration of realizing a process according to Example 1. A function of each unit illustrated in FIG. 2 is realized by the information processing apparatus 10.

The text recognition unit 20 accepts an image representing a text string of a text recognition target (hereinafter, referred to as a “target image”), and applies a text recognition process to the target image to recognize each text from the target image and recognize the text string of the text recognition target.

The target image is, for example, an image generated by scanning an original document (for example, a document) with a scanner, an image generated by imaging the original document with a camera, an image transmitted from an external apparatus to the information processing apparatus 10, or the like. For example, a text may be recognized from the target image by executing optical character recognition (OCR).

In addition, the text recognition unit 20 calculates a reliability degree of text recognition for each text recognized from the target image. That is, the text recognition unit 20 calculates a reliability degree of text recognition for each text (that is, a reliability degree of text recognition for the texts one by one). Hereinafter, a reliability degree of text recognition for one text will be referred to as a “text reliability degree”.

The text recognition unit 20 outputs a result of text recognition (that is, the text string of the text recognition target) and a text reliability degree for each text, to a partial text string extraction unit 22 and a partial reliability degree extraction unit 24. The result of text recognition is, for example, text data.

A specific text string is designated. The specific text string may be designated by the user or may be predetermined. The specific text string may be defined, based on a content represented in the target image. For example, since a number such as the amount of money has a required meaning in a bill, in a case where the target image is an image representing the bill, a specific text string is a text string of the amount of money. The specific text string is designated by using a regular expression such as the Grep command, for example.

The partial text string extraction unit 22 accepts the designation of the specific text string, and extracts the specific text string from the text string of the text recognition target. Information indicating a position of the specific text string in the text string of the text recognition target is output to the partial reliability degree extraction unit 24. Further, the specific text string is output as a result of text recognition.

For example, a numeric text string is designated as a specific text string, and the numeric text string is extracted from a text string of a text recognition target by using a regular expression indicating the numeric text string. As another example, a katakana text string is designated as a specific text string, and the katakana text string is extracted from a text string of a text recognition target by using a regular expression indicating the katakana text string. As still another example, an alphabet text string is designated as a specific text string, and the alphabet text string is extracted from a text string of a text recognition target by using a regular expression indicating the alphabet text string. Of course, a text string including other types of texts may be designated as a specific text string, or a combination of a plurality of types of texts maybe designated as the specific text string.

The partial reliability degree extraction unit 24 specifies each text constituting a specific text string included in a text string of a text recognition target based on a position of the specific text string in the text string of the text recognition target, and extracts a reliability degree of text recognition for each specified text (that is, a text reliability degree of each text). The text reliability degree of each text is output to a partial text string reliability degree calculation unit 26.

The partial text string reliability degree calculation unit 26 calculates a reliability degree of text recognition for the specific text string, based on the text reliability degree of each text constituting the specific text string. For example, the partial text string reliability degree calculation unit 26 may integrate the text reliability degrees of each text constituting the specific text string to determine a value obtained by the integration as the reliability degree of text recognition for the specific text string, or may specify a text having the lowest text reliability degree among a plurality of texts constituting the specific text string to determine a text reliability degree of the specified text as a reliability degree of text recognition for the specific text string. Hereinafter, the reliability degree of text recognition for the specific text string will be referred to as a “specific text string reliability degree”.

The specific text string reliability degree is output as a reliability degree of text recognition for an entirety of the text string of the text recognition target. For example, the specific text string reliability degree is illustrated on the display. The text string of the text recognition target or the specific text string may be displayed on the display together with the specific text string reliability degree.

For example, the text recognition unit 20 recognizes the text string of “billing amount is 1,000,000 yen every month.” which is a text recognition target, from the target image, and calculates a text reliability degree of each text constituting the text string. The partial text string extraction unit 22 extracts a specific text string of “1,000,000 yen” from the text string of “billing amount is 1,000,000 yen every month”. The partial reliability degree extraction unit 24 extracts a text reliability degree of each text constituting the specific text string of “1,000,000 yen”. The partial text string reliability degree calculation unit 26 calculates the specific text string reliability degree of the specific text string of “1,000,000 yen”, based on the text reliability degree of each text constituting the specific text string of “1,000,000 yen”. The specific text string reliability degree is output as a reliability degree of text recognition for an entirety of the text string of “billing amount is 1,000,000 yen every month.” which is a text recognition target.

As another example, the text recognition unit 20 recognizes a text string of “billing amount is $1,000” which is a text recognition target, from a target image, and calculates a text reliability degree of each text constituting the text string. The partial text string extraction unit 22 extracts a specific text string of “$1,000” from the text string of “billing amount is $1,000”. The partial reliability degree extraction unit 24 extracts a text reliability degree of each text constituting the specific text string of “$1,000”. The partial text string reliability degree calculation unit 26 calculates a specific text string reliability degree of the specific text string of “$1,000”, based on the text reliability degree of each text constituting the specific text string of “$1,000”. The specific text string reliability degree is output as a reliability degree of text recognition for an entirety of the text string of “billing amount is $1,000” which is a text recognition target.

### EXAMPLE 2

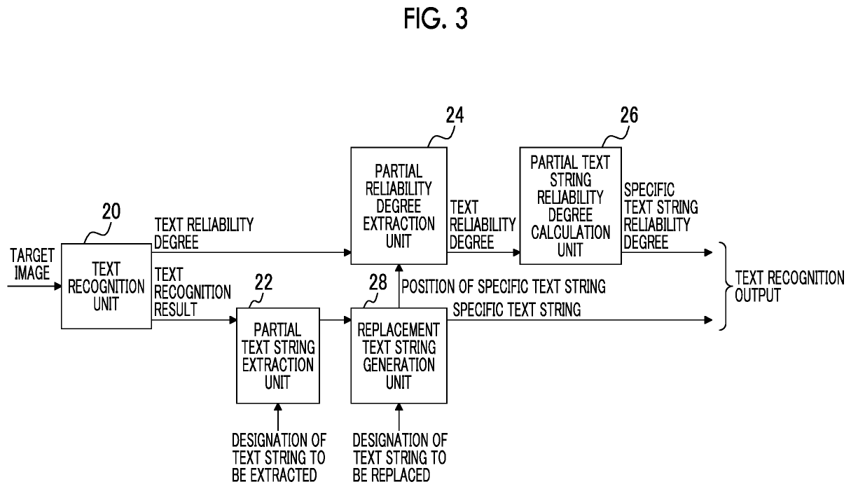

Hereinafter, Example 2 will be described with reference to FIG. 3. FIG. 3 illustrates a configuration of realizing a process according to Example 2. A function of each unit illustrated in FIG. 3 is realized by the information processing apparatus 10.

In Example 2, in addition to the configuration according to Example 1, a replacement text string generation unit 28 is used. A configuration other than the replacement text string generation unit 28 has the same manner as the configuration according to Example 1.

The replacement text string generation unit 28 replaces a specific text in a specific text string with another text. The partial text string reliability degree calculation unit 26 calculates a reliability degree of text recognition (that is, a specific text string reliability degree) for the specific text string in which the text is replaced. As the replacement of a text, the text may be deleted. The text to be replaced is designated by using a regular expression, for example.

The specific text to be replaced is, for example, a text having a reliability degree for text recognition equal to or less than a threshold value. For example, a comma “,”, a period “.”, “¥”, and a slash “/” are used. The comma and the dot can be misrecognized as each other, and the slash can be misrecognized as a number of “1”. Text recognition for such texts can have a low reliability degree, so such a text is designated as a specific text.

Hereinafter, a specific example of the process according to Example 2 will be described.

For example, a comma “,” included in a specific text string of “$1,000” may be misrecognized as a period “.”. That is, the specific text string of “$1,000” may be misrecognized as a text string of “$1,000”. In this case, the replacement text string generation unit 28 generates a text string of “$1000” by deleting the period “.” which is a specific text, from the text-recognized text string of “$1,000”. Based on a text reliability degree of each text constituting the text string of “$1000” from which the specific text is deleted, the partial text string reliability degree calculation unit 26 calculates a specific text string reliability degree of the specific text string of “$1000” from which the specific text is deleted. The specific text string reliability degree is output as a reliability degree of text recognition for an entirety of the text string of “billing amount is $1,000” which is a text recognition target.

As another example, even in a case where a specific text string of “$1,000” is recognized without being misrecognized, a reliability degree of text recognition for the comma “,” may be low. In this case, the replacement text string generation unit 28 deletes the comma “,” and generates a text string of “$1000”. A specific text string reliability degree for this text string is calculated and output.

As still another example, the replacement text string generation unit 28 may replace a period “ .” included in a text string of “$1,000”, which is a result of text recognition, with a comma “,”. A specific text string reliability degree of the text string after the replacement is calculated and output.

Hereinafter, still another specific example will be described.

For example, in a case where a specific text string is a text string representing the amount of money (for example, a text string in which a number is disposed after a mark “¥”), the “¥” that may have a low reliability degree is deleted, and a specific text string reliability degree of the text string after the deletion is calculated.

As still another example, in a case where the slash “/” is included in a specific text string, the slash “/” is deleted, and a specific text string reliability degree of the text string after the deletion is calculated.

As still another example, in a case where a specific text string is a text string representing the amount of money (for example, a text string of “number string yen/month”, a text string of “number string yen1month”, or the like), a text of “1” disposed between a text “yen” and a text “month” is replaced with a text “/”. A specific text string reliability degree may be calculated without using a reliability degree for the text of “1” or the text “/”.

Hereinafter, examples in which the “partial text string extraction unit 22” and the “replacement text string generation unit 28” are realized by using regular expressions will be described. For example, a target image is an image representing a text string described below.

Target image: “80,500 yen/month (consumption tax is not included)”

The partial text string extraction unit 22 extracts “a string of numbers separated by commas every 3 digits, any text” by using a regular expression described below. By using the regular expression described below, a plurality of three-digit numbers can be extracted.

Regular expression: \hat{ }(¥d{1, 3})(, ?(¥d{3}))??.*$

The replacement text string generation unit 28 refers to a portion of the three three-digit numbers as “$1, $3”, and deletes a comma. The regular expression used at this time is “$1$3”. As a result, a text string having only numbers is generated, such as a text string of “80500”. This text string is used as a specific text string, a specific text string reliability degree of this text string is calculated, and the specific text string reliability degree is output as a reliability degree of text recognition for an entirety of the text string, which is a text recognition target.

In a case where the reliability degree is a value between 0 and 1, the reliability degree for text recognition for an entirety of the text string of “80,500 yen/month (consumption tax is not included)” displayed in the target image becomes 0.52, for example. Since a value of 0.52 is a low value for a reliability degree, there is a possibility that misrecognition exists. For example, it is necessary for a person to check a result of text recognition.

On the other hand, the reliability degree of text recognition for the text string consisting of only numbers such as the text string of “80500” becomes 0.99, for example. In this manner, it is possible to obtain the high reliability degree. For example, there is no need for the person to check the result of text recognition.

In a case where the target image is an image representing a text string of “80,500,000 yen/month”, in the same manner, a text string of “80500000” is extracted, and a reliability degree of text recognition for the text string is calculated as a specific text string reliability degree.

Hereinafter, another example in which the “partial text string extraction unit 22” and the “replacement text string generation unit 28” are realized by using regular expressions will be described.

In the example described below, the replacement text string generation unit 28 converts an expression format of a specific text string into a specific expression format. A reliability degree of text recognition for the specific text string after the expression format is converted to the specific expression format is calculated, and the reliability degree is output as a reliability degree of text recognition for an entirety of the text string, which is a text recognition target. The expression format is, for example, an expression format of a date.

For example, a target image is an image representing a text string described below.

Target image: “2019/4 [symbol] ˜2019/9 [symbol] (from April 2019 to September 2019)”

The partial text string extraction unit 22 uses a regular expression described below to extract “a text string that allows some misrecognition from a start date to an end date”. By using the regular expression described below, a start year, a start month, an end year, and an end month are extracted.

Regular expression: \hat{ }([0-9|]{4}) [/1| [symbol] .]([1|][012|]|[1-9|]) [symbol] ?[˜˜¥−−]?(([0-9|]{4}) [/1| [symbol] .])?([1|][012|]|[1-9|])? [symbol] ?( [symbol] )?[ [symbol] ] [symbol] [0 .]?

The replacement text string generation unit 28 refers to the start year, the start month, the end year, and the end month as “$1, $2, $4, $5”, and replaces an expression format of the text string to be an expression format of “start year/start month to end year/end month”. The regular expression used at this time is “$1/$2˜$4/$5”. As a result, a text string having only the start year, the start month, the end year, and the end month is generated, such as a text string of “2019/4˜2019/9”. This text string is used as a specific text string, a specific text string reliability degree of this text string is calculated, and the specific text string reliability degree is output as a reliability degree of text recognition for an entirety of the text string, which is a text recognition target.

A reliability degree of text recognition for an entirety of the text string represented by the target image is, for example, 0.46. Since a value of 0.46 is a low value for a reliability degree, there is a possibility that misrecognition exists. For example, it is necessary for a person to check a result of text recognition.

On the other hand, a reliability degree of text recognition for a text string consisting of only numbers such as the text string of “2019/4˜2019/9” is calculated from 10 texts of “2009420199”, and the value becomes 0.98, for example. In this manner, it is possible to obtain the high reliability degree. For example, there is no need for the person to check the result of text recognition.

Hereinafter, still another example in which the “partial text string extraction unit 22” and the “replacement text string generation unit 28” are realized by using regular expressions will be described.

In the example described below, the replacement text string generation unit 28 converts an expression format of a specific text string into a specific expression format. A reliability degree of text recognition for the specific text string after the expression format is converted to the specific expression format is calculated, and the reliability degree is output as a reliability degree of text recognition for an entirety of the text string, which is a text recognition target.

For example, a target image is an image representing a text string described below.

Target image: “from 2019-04-01 to 2019-09-30”

An expression format of the text string represented in this target image is an expression format compliant with the international standard ISO8601.

The partial text string extraction unit 22 uses a regular expression described below to extract “from start date to end date, a text string that allows some misrecognition”. By using the regular expressions described below, the start year, the start month, the start date, the end year, the end month, and the end date are extracted.

Regular expression: \hat{ }fr[o00]m¥s?(¥d{4}) [−−]([01]) [0-9]) [−−]([0-3][0-9])¥s?t[o00]¥s?(¥d{4}) [−−]([01][0-9]) [−−]([0-9])$

The replacement text string generation unit 28 refers to the start year, the start month, the start date, the end year, the end month, and the end date as “$1, $2, $3, $4, $5, $6”, and replaces an expression format of the text string to be an expression format of “start year/start month/start date˜end year/end month/end date”. A regular expression used at this time is “$1/$2/$3˜$4/$5/$6”. As a result, a text string having only the start year, the start month, the start date, the end year, the end month, the end date is generated, such as a text string of “2019/04/01˜2019/09/30”. This text string is used as a specific text string, a specific text string reliability degree of this text string is calculated, and the specific text string reliability degree is output as a reliability degree of text recognition for an entirety of the text string, which is a text recognition target.

A reliability degree of text recognition for an entirety of the text string represented by the target image is, for example, 0.60. Since a value of 0.60 is a low value for a reliability degree, there is a possibility that misrecognition exists. For example, it is necessary for a person to check a result of text recognition.

On the other hand, a reliability degree of text recognition for a text string consisting of only numbers such as the text string of “2019/04/01˜2019/09/30” is calculated from 16 texts of “2019040120190930”, and the value becomes 0.90, for example. In this manner, it is possible to obtain the high reliability degree. For example, there is no need for the person to check the result of text recognition.

In each example described above, the text string output as a result of text recognition may be an entirety of the text string which is a text recognition target or a specific text string. For example, in a case where the target image is an image representing “billing amount is 1,000,000 yen every month.”, an entirety of the text string of “billing amount is 1,000,000 yen every month.” which is a result of text recognition for the target image may be output, or the whole may not be output and a text string of “1,000,000” which is a specific text string may be output. In either case, a reliability degree of text recognition for the specific text string of “1,000,00” is output.

In a case where the user checks a result of text recognition, a burden on the user for the checking can be reduced by outputting a reliability degree of the text recognition for a specific text string as in each example described above. For example, in a case where the reliability degree is high, a result of text recognition is not checked, a time required for the checking is shorter than in a case where the reliability degree is low, the result of the text recognition is not corrected, and the number of corrections is less than in a case where the reliability degree is low. Therefore, in a case where the checking operation is performed, a burden on the user for the checking is reduced by outputting the high reliability degree as compared with a case of outputting a low reliability degree. As described in the examples described above, a reliability degree of text recognition fora specific text string included in a text string which is a text recognition target tends to be higher than a reliability degree of text recognition for an entirety of the text string which is the text recognition target, so that by outputting the reliability degree of text recognition for the specific text string, a burden on the user burden for checking is reduced as compared with a case of outputting the reliability degree of text recognition for an entirety of the text string which is the text recognition target.

The function of each unit of the information processing apparatus 10 described above is realized by cooperation of hardware and software, as an example. For example, the function of each apparatus is realized by a processor of each apparatus reading and executing a program stored in a memory of each apparatus. The program is stored in the memory via a recording medium such as a CD or DVD, or via a communication path such as a network.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to:
extract a specific text string from a text string which is a text recognition target;
calculate a reliability degree of text recognition for the specific text string; and
output the reliability degree as a reliability degree of text recognition for an entirety of the text string which is the text recognition target.

2. The information processing apparatus according to claim 1,
wherein the specific text string is a text string according to a purpose of a user.

3. The information processing apparatus according to claim 2,
wherein the specific text string is a numeric text string.

4. The information processing apparatus according to claim 1, wherein the processor is further configured to:
replace a specific text in the specific text string with another text to calculate the reliability degree for the specific text string.

5. The information processing apparatus according to claim 2, wherein the processor is further configured to:
replace a specific text in the specific text string with another text to calculate the reliability degree for the specific text string.

6. The information processing apparatus according to claim 3, wherein the processor is further configured to:
replace a specific text in the specific text string with another text to calculate the reliability degree for the specific text string.

7. The information processing apparatus according to claim 4,
wherein the specific text is a text having a reliability degree equal to or less than a threshold value.

8. The information processing apparatus according to claim 5,
wherein the specific text is a text having a reliability degree equal to or less than a threshold value.

9. The information processing apparatus according to claim 6,
wherein the specific text is a text having a reliability degree equal to or less than a threshold value.

10. The information processing apparatus according to claim 1, wherein the processor is further configured to:
replace an expression format of the specific text string with a specific expression format to calculate the reliability degree for the specific text string.

11. The information processing apparatus according to claim 2, wherein the processor is further configured to:
replace an expression format of the specific text string with a specific expression format to calculate the reliability degree for the specific text string.

12. The information processing apparatus according to claim 3, wherein the processor is further configured to:
replace an expression format of the specific text string with a specific expression format to calculate the reliability degree for the specific text string.

13. The information processing apparatus according to claim 4, wherein the processor is further configured to:
replace an expression format of the specific text string with a specific expression format to calculate the reliability degree for the specific text string.

14. The information processing apparatus according to claim 5, wherein the processor is further configured to:
replace an expression format of the specific text string with a specific expression format to calculate the reliability degree for the specific text string.

15. The information processing apparatus according to claim 6, wherein the processor is further configured to:
replace an expression format of the specific text string with a specific expression format to calculate the reliability degree for the specific text string.

16. The information processing apparatus according to claim 7, wherein the processor is further configured to:
replace an expression format of the specific text string with a specific expression format to calculate the reliability degree for the specific text string.

17. The information processing apparatus according to claim 8, wherein the processor is further configured to:
replace an expression format of the specific text string with a specific expression format to calculate the reliability degree for the specific text string.

18. The information processing apparatus according to claim 9, wherein the processor is further configured to:
replace an expression format of the specific text string with a specific expression format to calculate the reliability degree for the specific text string.

19. The information processing apparatus according to claim 1, wherein the processor is configured to:
based on a reliability degree of text recognition for each text constituting the specific text string, calculate the reliability degree of text recognition for the specific text string.

20. A non-transitory computer readable medium storing a program causing a computer to execute a process comprising:
extracting a specific text string from a text string which is a text recognition target;
calculating a reliability degree of text recognition for the specific text string; and
outputting the reliability degree as a reliability degree of text recognition for an entirety of the text string which is the text recognition target.
